(19) United States
(12) Patent Application Publication
(10) Pub. No.: US 2004/0111707 A1
(43) Pub. Date: Jun. 10, 2004

(54) Debugger for multiple processors and multiple debugging types

(76) Inventors: Andrew L. Bliss, Redmond, WA (US); Andre Vachon, Redmond, WA (US)

Correspondence Address: WOODCOCK WASHBURN KURTZ, MACKIEWICZ & NORRIS LLP, ATTENTION: STEVEN J. ROCCI, ESQ., ONE LIBERTY PLACE, 46TH FLOOR, PHILADELPHIA, PA, 19103, US

(21) Appl. No.: 09/681,064

(22) Filed: Dec. 15, 2000

(51) Int. Cl. G06F 9/44

(52) U.S. Cl. 717/129; 717/131; 717/143

(57) ABSTRACT

A debugger can debug any of a plurality of debuggees. Each debuggee has a debugging type attribute selected from a plurality of debugging type attributes and representative of a type of debugging to be performed with respect to the debuggee. Each debuggee also has a processor attribute selected from a plurality of processor attributes and representative of a type of processor associated with the debuggee. The debugger is instantiated on a computer, and has an engine for performing debugging functions with respect to any of the plurality of debuggees. The engine includes a plurality of debugging type blocks, where each debugging type block supports at least one of the plurality of debugging type attributes, and a plurality of processor blocks, where each processor block supports at least one of the plurality of processor attributes. In operation, the debugging type attribute of a particular debuggee is determined, and a particular debugging type block is selected for debugging the particular debuggee based on the determined debugging type attribute. Likewise, the processor attribute of the particular debuggee is determined, and a particular processor block is selected for debugging the particular debuggee based on the determined processor attribute. Thereafter, the selected debugging type block and the selected processor block are employed to debug the particular debuggee.

### BACKGROUND OF INVENTION

1. Technical Field

The present invention relates to a debugger for debugging computer code from a debugging type and a processor. More specifically, the present invention relates to such a debugger for debugging computer code from any of several debugging types on any of several processors such that multiple debuggers for the several debugging types and processors are not necessary.

2. Background of the Invention

In general, and as known, a debugger is a virtual object instantiated on a computer or the like, and may for example include an engine that performs debugging functions and an executable that provides an interface between the engine and a user. Typically, in an IBM personal computer-type processing environment or the like, the engine is instantiated from a .dll-type file or the like, and the executable is instantiated from a .exe-type file or the like, where the user runs the executable and the executable calls the engine. The debugger runs on a host machine and debugs a debugged entity which may be another process on the host machine, another machine, or a dumped debug file from a machine.

Prior to the present invention, the engine in particular was written for a specific type of debugging and for a specific type of processor/machine. Types of debugging include kernel mode from a live machine, kernel mode from a dump file, user mode from a live machine, user mode from a dump file, and the like, while types of processors include the x86 family, the Alpha family, the IA64 family, and the like. As may be appreciated, then, a multitude of binaries exist, such as for example a user mode x86 debugger, a kernel mode Alpha debugger, etc. As may also be appreciated, each of the multitude of binaries must be supported, updated, and otherwise generally maintained. Consequently, supporting, updating, and maintaining all of the multitude of binaries is a considerable task requiring much time and effort. In addition, since each debugger having a different engine is specific to a particular environment, a user must carefully select the appropriate debugger when debugging.

Thus, a need exists for a single debugger engine that supports multiple debugging types and multiple processors such that supporting, updating, and maintaining the single debugger engine is greatly simplified. In particular, a need exists for a single debugger engine that supports dynamic selection from among the multiple debugging type and multiple processors and thereby supports all available debugging operations. Thus, a debugger user need not be concerned with selecting a particular debugger for debugging.

### SUMMARY OF INVENTION

In the present invention, a debugger can debug any of a plurality of debuggees. Each debuggee has a debugging type attribute selected from a plurality of debugging type attributes and representative of a type of debugging to be performed with respect to the debuggee. Each debuggee also has a processor attribute selected from a plurality of processor attributes and representative of a type of processor associated with the debuggee. The debugger is instantiated on a computer, and has an engine for performing debugging functions with respect to any of the plurality of debuggees. The engine includes a plurality of debugging type blocks, where each debugging type block supports at least one of the plurality of debugging type attributes, and a plurality of processor blocks, where each processor block supports at least one of the plurality of processor attributes.

In operation, the debugging type attribute of a particular debuggee is determined, and a particular debugging type block is selected for debugging the particular debuggee based on the determined debugging type attribute. Likewise, the processor attribute of the particular debuggee is determined, and a particular processor block is selected for debugging the particular debuggee based on the determined processor attribute. Thereafter, the selected debugging type block and the selected processor block are employed to debug the particular debuggee.

### BRIEF DESCRIPTION OF DRAWINGS

The foregoing summary, as well as the following detailed description of the embodiments of the present invention, will be better understood when read in conjunction with the appended drawings. For the purpose of illustrating the invention, there are shown in the drawings embodiments which are presently preferred. As should be understood, however, the invention is not limited to the precise arrangements and instrumentalities shown.

In the drawings:

FIG. 1 is a block diagram representing a general purpose computer system in which aspects of the present invention and/or portions thereof may be incorporated;

FIG. 2 is a block diagram representing a typical debugger including an executable and engine as coupled to a processor or as receiving a dump file from a processor;

FIG. 3 is a block diagram of the debugger engine of FIG. 1 in accordance with one embodiment of the present invention;

FIGS. 4 and 5 are block diagram showing the tree structure of code employed in the debugger type abstraction (FIG. 4) and processor abstraction (FIG. 5) of the engine of FIG. 3 in accordance with one embodiment of the present invention; and

FIG. 6 is a flow diagram showing typical steps performed in operating the debugger of FIG. 2 in accordance with one embodiment of the present invention.

### DETAILED DESCRIPTION

Computer Environment

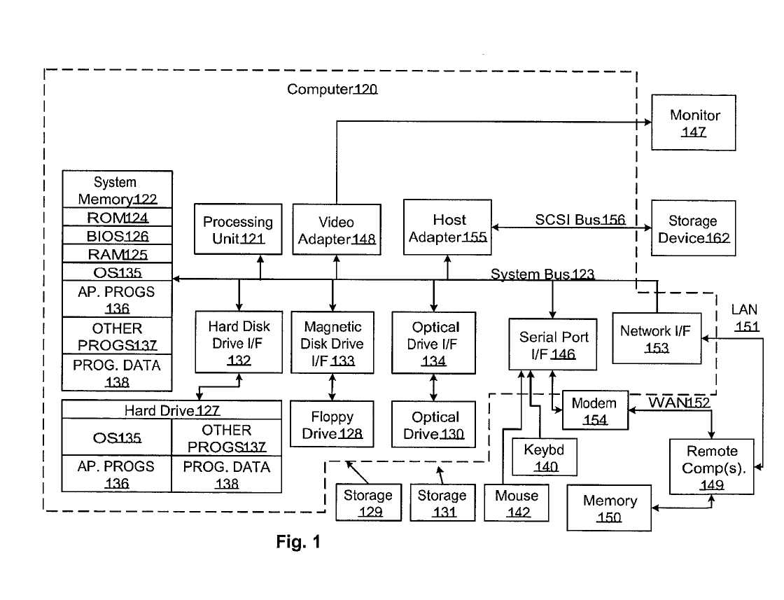

FIG. 1 and the following discussion are intended to provide a brief general description of a suitable computing environment in which the present invention and/or portions thereof may be implemented. Although not required, the invention is described in the general context of computer-executable instructions, such as program modules, being executed by a computer, such as a client workstation or a server. Generally, program modules include routines, programs, objects, components, data structures and the like that perform particular tasks or implement particular abstract data types. Moreover, it should be appreciated that the invention and/or portions thereof may be practiced with other computer system configurations, including hand-held devices, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

As shown in FIG. 1, an exemplary general purpose computing system includes a conventional personal computer 120 or the like, including a processing unit 121, a system memory 122, and a system bus 123 that couples various system components including the system memory to the processing unit 121. The system bus 123 may be any of several types of bus structures including a memory bus or memory controller, a peripheral bus, and a local bus using any of a variety of bus architectures. The system memory includes read-only memory (ROM) 124 and random access memory (RAM) 125. A basic input/output system 126 (BIOS), containing the basic routines that help to transfer information between elements within the personal computer 120, such as during start-up, is stored in ROM 124.

The personal computer 120 may further include a hard disk drive 127 for reading from and writing to a hard disk (not shown), a magnetic disk drive 128 for reading from or writing to a removable magnetic disk 129, and an optical disk drive 130 for reading from or writing to a removable optical disk 131 such as a CD-ROM or other optical media. The hard disk drive 127, magnetic disk drive 128, and optical disk drive 130 are connected to the system bus 123 by a hard disk drive interface 132, a magnetic disk drive interface 133, and an optical drive interface 134, respectively. The drives and their associated computer-readable media provide non-volatile storage of computer readable instructions, data structures, program modules and other data for the personal computer 120.

Although the exemplary environment described herein employs a hard disk, a removable magnetic disk 129, and a removable optical disk 131, it should be appreciated that other types of computer readable media which can store data that is accessible by a computer may also be used in the exemplary operating environment. Such other types of media include a magnetic cassette, a flash memory card, a digital video disk, a Bernoulli cartridge, a random access memory (RAM), a read-only memory (ROM), and the like.

A number of program modules may be stored on the hard disk, magnetic disk 129, optical disk 131, ROM 124 or RAM 125, including an operating system 135, one or more application programs 136, other program modules 137 and program data 138. A user may enter commands and information into the personal computer 120 through input devices such as a keyboard 140 and pointing device 142. Other input devices (not shown) may include a microphone, joystick, game pad, satellite disk, scanner, or the like. These and other input devices are often connected to the processing unit 121 through a serial port interface 146 that is coupled to the system bus, but may be connected by other interfaces, such as a parallel port, game port, or universal serial bus (USB). A monitor 147 or other type of display device is also connected to the system bus 123 via an interface, such as a video adapter 148. In addition to the monitor 147, a personal computer typically includes other peripheral output devices (not shown), such as speakers and printers. The exemplary system of FIG. 1 also includes a host adapter 155, a Small Computer System Interface (SCSI) bus 156, and an external storage device 162 connected to the SCSI bus 156.

The personal computer 120 may operate in a networked environment using logical connections to one or more remote computers, such as a remote computer 149. The remote computer 149 may be another personal computer, a server, a router, a network PC, a peer device or other common network node, and typically includes many or all of the elements described above relative to the personal computer 120, although only a memory storage device 150 has been illustrated in FIG. 1. The logical connections depicted in FIG. 1 include a local area network (LAN) 151 and a wide area network (WAN) 152. Such networking environments are commonplace in offices, enterprise-wide computer networks, intranets, and the Internet.

When used in a LAN networking environment, the personal computer 120 is connected to the LAN 151 through a network interface or adapter 153. When used in a WAN networking environment, the personal computer 120 typically includes a modem 154 or other means for establishing communications over the wide area network 152, such as the Internet. The modem 154, which may be internal or external, is connected to the system bus 123 via the serial port interface 146. In a networked environment, program modules depicted relative to the personal computer 120, or portions thereof, may be stored in the remote memory storage device. It will be appreciated that the network connections shown are exemplary and other means of establishing a communications link between the computers may be used.

System and Method of the Present Invention

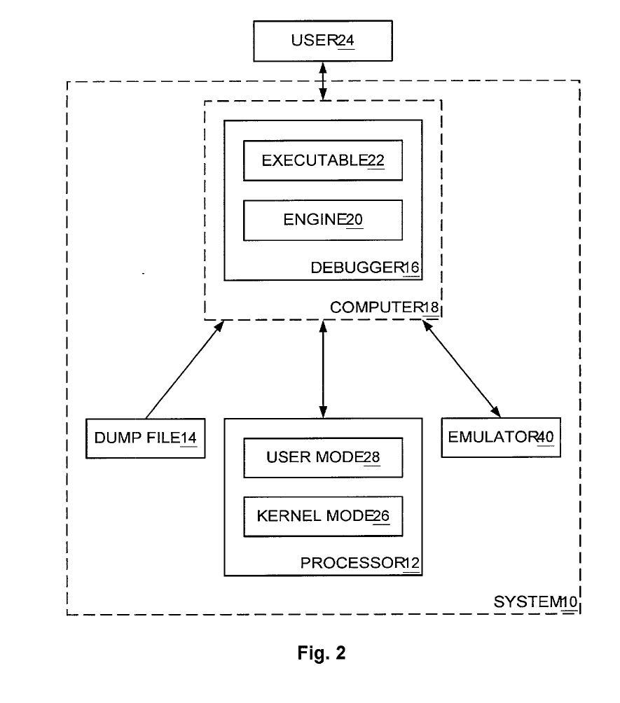

Referring to the drawings in details, wherein like numerals are used to indicate like elements throughout, there is shown in FIG. 2 a system 10 for debugging a live processor 12 or a dump file 14 as obtained from the live processor 12. As seen, the system 10 includes a debugger 16 which is a virtual object instantiated on a computer 18 or the like, and the debugger 16 includes an engine 20 that performs debugging functions and an executable 22 that provides an interfaces between the engine 20 and a user 24. As was pointed out above, the engine 20 is typically instantiated from a .dll-type file or the like, and the executable 22 is typically instantiated from a .exe-type file or the like, where the user 24 runs the executable 22 and the executable 22 calls the engine 20.

As known, the user 24 employs the debugger 16 on the computer to control the processor 12 and access data stored on the processor 12, or to read the dump file 14 as obtained from the processor 12, all during a debugging operation involving the processor 12 and/or dump file 14. As is also known, the processor 12 may be operating multiple modes, including a kernel mode 26 for conducting operations more central to the processor 12 and/or a user mode 28 for conducting operations more peripheral to the processor, where each of the kernel and user modes 26, 28 has its own processing and memory devices and the like. Thus, the debugger 16 must accommodate the particular mode 26, 28 that the processor 12 is operating in/produced the dump file 14.

Methods of employing a debugger 16 to debug a processor 12 are known or should be apparent to the relevant public and therefore need not be described herein in any detail. Any particular method of instantiating the debugger 16 may be employed without departing from the spirit and scope of the present invention. More generally, the user 24 may be any particular user, be it a person or another machine, and the processor 12, dump file 14, computer 18, and executable 22 may be any particular processor, dump file, computer, and executable, respectively, all without departing from the spirit and scope of the present invention. Also, the processor 12 may have any particular kind of mode or kinds of modes without departing from the spirit and scope of the present invention.

As shown in FIG. 2, the computer 18 is separate from the processor 12, dump file 14, and emulator 40 (discussed below). However, and importantly, such items may be combined with or placed on the computer 18 without departing from the spirit and scope of the present invention. In fact, this is the case in many instances. However, in other instances, such as for example live kernel mode debugging, the processor 12 is in fact separate from the computer 18. Presumably, the debugger 16 on the computer 18 is interfaced to the processor 12 in an appropriate manner (when in fact separate from the processor 12), and the user 24 is interfaced to the debugger 16 by way of the executable 22 also in an appropriate manner. Such interfacing may require that the user 24, computer 18 and processor 12 all be located in the same place, or may allow one or more of the user 24, computer 18 and processor 12 to be remote from the others. The details of such interfacing are known and therefore need not be discussed herein in any detail. Accordingly, any interfacing mechanism may be employed without departing from the spirit and scope of the present invention.

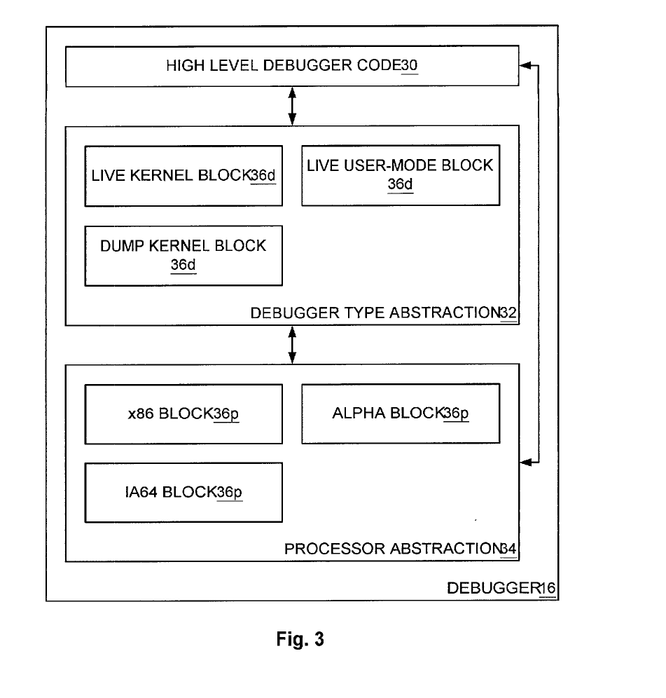

In one embodiment of the present invention, and referring now to FIG. 3, the debugger 16 has a single debugger engine 20 that supports debugging for each of multiple debugging types and each of multiple processors. As a result, supporting, updating, and maintaining the single debugger engine 20 is greatly simplified. The single debugger engine 20 supports dynamic selection from among the multiple debugging type and multiple processors 12 and thereby supports all available debugging operations. By allowing a single engine 20 to support all the different debugging types and processors encountered, the engine 20 has greatly increased flexibility, development thereof is much more uniform, and modification thereof is simplified.

As seen in FIG. 3, the single engine 20 of the present invention includes three functional parts: high level debugger code 30, a debugging type abstraction 32, and a processor abstraction 34. Of course, other parts may be included in the single engine 20 without departing from the spirit and scope of the present invention.

The high level debugger code 30 issues generic requests based at least partly on commands as received from the user 24 byway of the executable 22. Such requests are on the order of reading data from a particular source, writing data to a particular destination, and other similar requests that apply across all debugging types and processors. The higher-level debugger code 30 uses the services provided by the debugging type abstraction 32 and the processor abstraction 34 to accomplish debugging actions such as reading memory, setting breakpoints, disassembling instructions, etc. and is thereby insulated from debugging type-specific and processor-specific code. The debugging type abstraction 32 and the processor abstraction 34 may use services from each other when necessary or may implement the required behavior directly.

The debugging type abstraction 32 contains programming code for the type of debugging, where such code is not processor-sensitive. Such debugging type abstraction code actually performs work, such as for example making calls to read data from a dump file or processor 12 or write data to the processor 12. The debugging type abstraction 32 thus provides services for accessing memory, processor and machine context, system information, breakpoint insertion and removal, execution control and other items that vary in implementation for each debugging type. Functionally, then, the debugging type abstraction 32 includes a separate block 36d for each kind of debugging: a block 36d that performs kernel mode debugging, a block 36d that performs user mode debugging, a block 36d that performs dump file debugging for a kernel mode dump file, a block 36d that performs dump file debugging for a user mode dump, a block 36d that performs user-mode debugging of a program running on an emulator, etc.

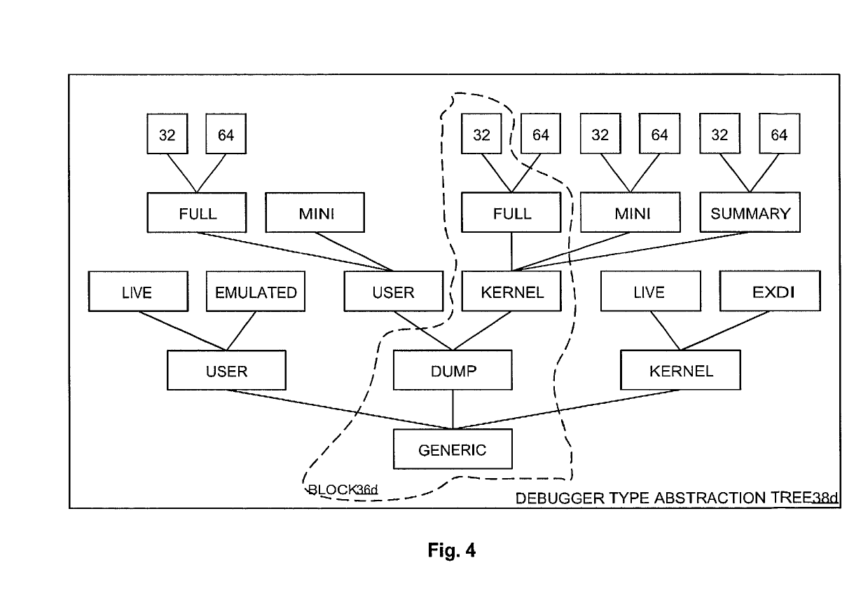

Owing to the fact that some of the programming code for the debugging type abstraction 32 is common as between blocks 36d, such common code is in fact shared as appropriate. In one embodiment of the present invention, and as seen in FIG. 4, the code for the debugging type abstraction 32 is organized in the form of a tree 38d with generic code at the base and more specific levels of code branching out therefrom. Each block 36d thus includes several nodes from the tree 38d.

The processor abstraction 34 contains programming code for the type of debugging, where such code is in fact processor-sensitive. Such processor abstraction code also actually performs work, although in this case the work is of the type specific to a processor 12, such as for example disassembling code from the processor 12 or from a dump file 14 from the processor 12. Thus, the processor abstraction 34 provides services which require processor-specific code, such as for recognizing particular instructions or processor state, maintaining hardware breakpoints, assembly and disassembly and so on. Similar to the debugging type abstraction 32, the processor abstraction 34 includes a separate functional block 36p for each kind of processor 12: a block 36p for an x86-type processor, a block 36p for an Alpha-type processor, a block 36p for an IA64-type processor, etc.

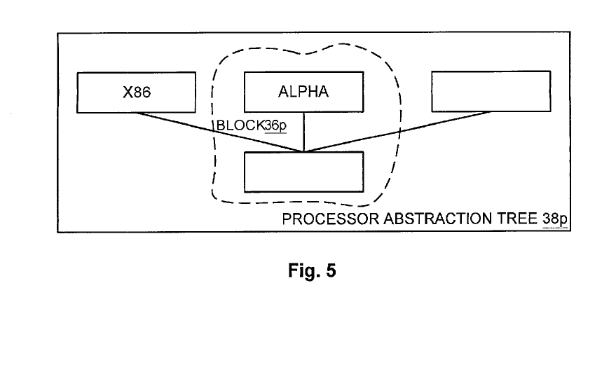

Once again, owing to the fact that some of the programming code for the processor abstraction 34 is common as between blocks 36p, such common code is in fact shared as appropriate. In one embodiment of the present invention, and referring now to FIG. 5, the code for the processor abstraction 34 is organized in the form of a tree 38p with generic code at the base and more specific levels of code branching out therefrom. Each block 36p thus includes several nodes from the tree 38p.

In one embodiment of the present invention, each of the high level debugger code 30, the debugging type abstraction 32, and the processor abstraction 34 is coded according to a programming language such as C++, although other languages may be employed without departing from the spirit and scope of the present invention. Following is a more detailed discussion of each of the debugging type abstraction 32 and the processor abstraction 34.

The Debugging Type Abstraction 32

In one embodiment of the present invention, the engine 20 of the debugger 16 on the computer 18 supports live kernel debugging of the processor 12, live kernel debugging of the computer 18 itself, live kernel debugging of a hardware emulator 40 (FIG. 2) connected through an appropriate interface, triage (small) kernel dumps, summary (kernel memory only) kernel dumps, full kernel dumps, live user-mode debugging of processes such as Win32 (WINDOWS 32-bit operating system, a product of MICROSOFT Corporation of Redmond, Wash.) processes, live user-mode debugging of programs running in emulators that are processes such as Win32 processes, mini user-mode dumps, and full user-mode dumps. In such embodiment, the engine 20 supports both 32- and 64-bit kernels, processes and dump files 14. As should be appreciated, each different kind of debugging requires different operations for tasks such as accessing memory, breakpoint insertion and removal, etc. The actual mechanics of such tasks and of implementing such tasks in each kind of debugging is known or should be apparent to the relevant public and therefore need not be described herein in any detail.

As may be appreciated, the debugging type abstraction 32 in effect hides the actual operations performed for each particular type of debugging so that the high level debugger code 30 can simply call the debugging type abstraction 32 to carry out some desired debugging action. The general pattern of implementation for blocks 36d of the debugging type abstraction 32 may be broken down into the following categories:—A user-mode Win32-type debugging block 36d uses services built into a Win32-type operating system to perform most tasks. As may be appreciated, Win32 has a section of its API interface devoted to debugging services and the user-mode Win32-type debugging block 36d uses such operating system services to perform tasks. A local kernel debugging block 36d works in a similar manner through a system service created specifically for local kernel debugging.

A dual-machine kernel mode debugging block 36d performs tasks by sending messages back and forth between the computer 18 on which the debugger 16 resides and the processor 12 being debugged. The dual-machine live kernel block 36d thus includes a communication sub-block which handles all remote communications tasks. Operations on the kernel of the processor 12 are turned into requests which are sent to the computer 18. The processor 12 also receives and interprets requests from the computer 18 for traffic in the other direction.

A live kernel debugging block 36d debugging a hardware emulator 40 performs tasks in a manner similar to dual-machine debugging in that two machines (computer 18, emulator 40) are involved, but in this case the communication is not explicit but rather is hidden behind an interface for hardware emulators 40. The interface may be a standard interface such as eXDI or another interface. in the case of eXDI, an eXDI live kernel target block 36d instantiates the eXDI interface and makes calls on such interface to perform tasks.

Dump files 14 contain static information, and accordingly a dump file block 36d need only provide an interface to the information contained in the dump file 14. In one embodiment of the present invention, the engine 20 of the debugger 18 supports multiple kinds of dump files 14 in both 32- and 64-bit versions. As a result, such embodiment has a large number of dump-file-specific blocks 36d. In each case, such block 36d is tailored to the particular data structures and information present in the kind of dump file 4 such block 36d is directed toward. As may be appreciated, dump file blocks 36d may share substantial amounts of code in the manner discussed in connection with FIG. 4, especially with regard to dump files 14 having similar structures. Thus, kernel dump and user dump families may be identified.

User-mode processes running in an emulator 40 are similar to kernel processes running in such emulator 40 in that the debugger 16 cannot directly control or access the debuggee as communication is with the emulator 40 and not directly with the emulated item. Accordingly, an appropriate block 36d for such case instantiates an interface specific to the emulator 40 and makes method calls on such interface to perform tasks.

In one embodiment of the present invention, the engine 20 of the debugger 16 initially starts out not knowing what type of debugging is going to occur, and therefore does not know which block 36d to employ for debugging tasks. At some point during the execution of the debugger 16, the user 24 will either directly or indirectly make a selection of what kind of debugging to do, such as by starting a user-mode program on the computer 18 to debug, connecting to a processor 12 for kernel debugging, or opening a dump file 14. At that point the debugging type is determined and the appropriate block 36d of the debugging type abstraction 32 is located and employed. In particular, a global variable is set to the selected block 36d for high level debugger code 30 to use when requesting debugging type services. An initialize method may be called to allow the selected block 36d to enter an initial state.

In one embodiment of the present invention, an ‘un-initialized’ block 36d is employed for the un-initialized state which fails all its methods with an informative error message. Such un-initialized block 36d is active in the time before an actual functional block 36d is chosen so that high level debugger code 30 requests can fail gracefully before the functional block 36d is initialized. The un-initialized block 36d also serves as an inheritance base so that operations which are not implemented in a specific block 36d will use the base failure method and fail gracefully just as in the un-initialized case. For example, dump-type blocks 36d do not support breakpoints and instead inherit their implementation of breakpoint methods from the special un-initialized block 36d. Any request for a breakpoint on a dump-type block 36d therefore fails gracefully without any special work on the part of such dump-type block 36d.

When a user 24 terminates a debug session, the block 36d employed in the debugger type abstraction 32 reverts from the specific block 36d to the un-initialized block 36d. At that point, the debugger 16 is ready to begin a new debug session. The specific block 36d of the new session can be totally unrelated to the previous specific block 36d.

A common operation in the debugger 16 is to read the virtual address space of a debuggee (i.e., processor 12, dump file 14, emulator 40, etc.) to determine what the state of memory is for such debuggee. In one embodiment of the present invention, the blocks 36d of the debugger type abstraction 32 share a set of methods which abstract this access for many different kinds of debuggee information. The debugger type abstraction 32 thus allows access to virtual memory, physical memory, I/O space, system control space, bus data, machine-specific registers, etc. of the debuggee. The actual implementations of such access vary widely between block 36d and not all information is available for all blocks 36d. For example:—User-mode Win32 programs only have a virtual address space. Win32 itself provides operating system functions, ReadProcessMemory and WriteProcessMemory, which the user-mode block 36d can call to retrieve virtual memory information. Such block 36d thus functions as a simple interface conversion in this case.

Dual-machine kernel debugging requires that a request be sent from the computer 18 of the debugger 16 to the debuggee to retrieve requested information. In this case, the selected block 36d formats such a request and sends it to the debuggee for fulfillment and waits for completion of the operation. In addition, because this method of communication can be relatively slow, the block 36d can implement a cache of retrieved memory information. The block 36d retrieval methods check the cache initially and can return data directly from the cache to increase performance. The block 36d also allows the cache to be bypassed if so desired.

An emulator-type block 36d that debugs through eXDI or other emulators simply calls through the emulator interface methods for memory access. Local kernel debugging makes use of the system services for local kernel debugging.

A kernel dump file 14 only contains physical memory pages, so a request for virtual memory requires the selected block 36d to translate the virtual address to a physical address before accessing memory. Again this can sometimes be costly so the block 36d can cache translations and physical pages, much as an actual processor might.

A user dump file 14 only contains virtual memory, so a user dump block 36d can only retrieve virtual memory. Other memory requests fail. When a virtual memory request comes, in the user dump block 36d matches the requested memory to a part of the dump file through included virtual memory mapping tables.

None of this complexity is exposed to the high level debugger code 30. Such code 30 simply makes a memory request and the selected block 36d does whatever is necessary.

As was discussed above in connection with FIG. 4, the use of shared code allows common implementations to be shared amongst blocks 36d. For example, some blocks 36d do not implement memory caching. In this case, methods such as ReadVirtual and ReadVirtualUncached perform the same operation since there is no cache to bypass. A base block 36d provides this simple mapping so that it can be inherited by blocks 36d which do not use a cache. Blocks 36d which do use a cache override the methods to implement their cache.

Another example of reuse is the SearchVirtual method. In the case of a remote kernel machine debugging session, SearchVirtual actually formats a request for the search and sends it to the remote machine. The actual search is carried out on the remote machine for maximum efficiency. In the case of a user-mode Win32 or dump file debugging session, no such mechanism exists and SearchVirtual just retrieves memory via ReadVirtual and scans for the requested pattern. As with ReadVirtualUncached, the base block 36d provides this layered SearchVirtual implementation and only certain blocks 36d override such implementation.

Another common debugger operation is retrieving the current processor context. As with memory, this may require very different operations in different blocks 36d. In addition to just the variety of ways to retrieve processor contexts, the debugger 16 of the present invention supports different operating systems and different versions of the same operating system, each of which may have their own notion of what a processor context is. Finally, different sets of registers may be available depending on the privilege level of the debuggee, such as extra registers being accessible from a kernel debuggee.

The selected block 36d cooperates with the computer 18 upon which the debugger 16 resides to retrieve processor contexts and convert them to a canonical form for the debugger 16. In this case, the block 36d accesses processor context information and the computer 18 has the process-specific code necessary to convert to the canonical form.

The selected block 36d of the debugger type abstraction 32 also has responsibility for abstracting differences in operating systems running underneath the debuggee (processor 12, dump file 14, emulator 40, etc.). Such selected block 36d provides:—Simple methods for accessing operating system information about processes and threads. The information available for a thread varies widely between operating systems and versions of operating systems and the target does not attempt to convert them, it only abstracts the retrieval of such information.

Methods for scanning the operating system's list of currently loaded code modules. Often a debugger 16 is started on a debuggee after the debuggee has already been running. The user 24 of the debugger 16 needs to be able to find out what code modules are currently in use in the debuggee so the debugger 16 needs to be able to find out that information by inspecting the debuggee. This generally involves decoding the operating system's list of currently loaded modules. The selected block 36d provides an abstraction of a module list which allows the high level debugger code 30 to walk the currently loaded set of modules for all supported operating systems and versions. The selected block 36d also supports a high level debugger code 30 module information reloading method which works with string module names and handles all of the common cases of module list scanning.

The selected block 36d knows how to retrieve version information for all of the supported operating systems and provides a method which will display all the version information collected.

During a debugging session, the debugger 16 of the present invention must be able to start and stop the debuggee and be able to control the granularity of execution of the debuggee. Typically, the debuggee as controlled by the debugger 16 either runs freely or is stepped incrementally. When the debuggee is running freely, the debugger 16 must wait for something to happen in the debuggee to determine when the debuggee has stopped running. In one embodiment of the present invention, each block 36d of the debugger 16 is provided with methods to handle all available types of debuggee execution control:—WaitForEvent allows the debugger 16 to wait for something to happen in a debuggee. WaitForEvent also restarts the debuggee if the debuggee was not running. WaitForEvent can start the debuggee for free run or other execution modes based on global state set before the call to WaitForEvent.

RequestBreakIn forces an event to occur in a debuggee so that WaitForEvent can return.

Reboot restarts the debuggee, assuming such debuggee supports such operation, so that a fresh session can begin.

Along with raw execution control, the debugger 16 must be able to stop a debuggee at points of interest indicated by the user 24. The debugger 16 does so by marking the spot with a breakpoint. Thus, execution at such spot will trigger a breakpoint event and activate the debugger 16. The selected block 36d abstracts what exactly is required to mark a spot and what exactly constitutes a breakpoint. The high level debugger code 30 simply asks that a particular kind of breakpoint be inserted at a particular spot and the selected block 36d handles the actual processing.

The Processor Abstraction 34

In one embodiment of the present invention, the processor abstraction 34 of the debugger 16 includes blocks 36p for supporting multiple families of processors 12, including but not limited to the x86, Alpha and IA64 families of processors. Each processor family has its own set of registers, instruction set and other unique hardware features. Each block 36p also represents system information that is sensitive to the corresponding processor 12, such as the system processor context structure.

As was discussed above, in initializing the engine 20 of the debugger 16 of the present invention for use in connection with a particular debugging operation, a particular block 36d from the debugger type abstraction 32 is selected. Thereafter, a particular block 36p from the processor abstraction 34 is also selected. In one embodiment of the present invention, such selection of the particular block 36p occurs by having the selected block 36d determine the type of the particular debuggee (processor 12, dump file 14, computer 18, emulator 40, etc.). Upon such determination, the block 36d instantiates the appropriate block 36p and the debugger 16 is fully initialized.

In the case of a user-mode or dump file block 36d of the debugger type abstraction, it is to be appreciated that all of the necessary information is immediately available to such block 36d, and the debuggee is immediately recognizable. In a dual-machine live kernel debugging session, however, the block 36d does not know the processor type of the debuggee until a remote connection with such debuggee becomes active and the debuggee sends appropriate information about itself to the debugger 16 on the host computer 18.

The debuggee can be reset due to events occurring therein or by user interaction. When doing dual-machine live kernel debugging, the debuggee may reboot or be rebooted. When the remote connection is reestablished, the operating system of the debuggee may have changed in the case where the debuggee has multiple operating systems installed, or the debuggee itself may have changed if the user 24 physically changes connections between the computer 18 on which the debugger 16 resides and the debuggee. In either case, the new debuggee may be unrelated to the old debuggee. In user mode, the user 24 can ask that a debugging session be restarted. In such case, the debuggee is reset and the debugger 16 goes back to the un-initialized state before restarting.

In one embodiment of the present invention, the selected block 36p of the processor abstraction 34 obtains and holds descriptive information about and specific to the debuggee, be it a processor 12, a dump file 14, the computer 18 upon which the debugger 16 resides, an emulator 40, etc. Such descriptive information includes a name for the debuggee, the registers available on the machine, the size of offset information for processor-related information and system data structures, and the like. Such descriptive information as obtained by the selected block 36p is then available to the remainder of the debugger 16.

In one embodiment of the present invention, the selected block 36p also obtains currently available processor context information and holds such context information in an appropriate structure. The selected blocks 36d, 36p of the abstractions 32, 34 may then access such structure and employ code which understands particular processor contexts. Generic code can go through the abstracted register access methods. The selected block 36p also provides methods as necessary for retrieving and converting processor context information. While the selected block 36d of the debugger type abstraction 32 is ultimately responsible for retrieving raw context information, the selected block 36p of the processor abstraction 34 is responsible for converting the raw context information into a canonical processor context structure available to the debugger 16.

In one embodiment of the present invention, the selected block 36p of the processor abstraction 34 also implements a simple delay-loading scheme for processor context information. A full processor context can be relatively large so, as with memory requests, processor contexts can be cached in the debugger 16. Such caching works at a level determined by a particular selected block 36p and generally breaks down into logical chunks of processor state that are usually retrieved together. For example, a block 36p may clump all of the user-mode processor state together for retrieval but keep such state separate from the extended kernel-mode processor state. If all that is used is the user-mode state, the block 36p never needs to retrieve the kernel-mode state. The granularity of caching is entirely up to the block 36p. Such block 36p can thus choose to clump integer registers separately from floating-point registers or even finer grain distinctions if so desired.

In one embodiment of the present invention, the selected block 36p of the processor abstraction 34 provides a set of methods for retrieving processor context information in a generic way so that common processor concepts, such as an instruction pointer, can be retrieved in a consistent way across all supported debuggees. The common registers are the instruction pointer, stack pointer and frame pointer. Supported processors 12 may not always have a direct mapping for a common register, although there is usually a mapping that provides information consistent with common usage. Another piece of common processor state is the trace flag for single stepping. Processors 12 support hardware single stepping in different ways if at all, so the selected block 34p provides abstracted control over tracing state. The selected block 36p is responsible for mapping the requesting stepping to a method supported by the particular processor 12.

In addition to the common registers the machine provides an enumeration-based register access scheme so that callers can discover the actual set of registers available and enumerate through them to discover their type and access their information. This allows a debugger to implement a generic register user interface by enumerating the machine's registers and displaying them. Such a debugger will automatically work with all supported machines.

In one embodiment of the present invention, the selected block 36p also provides code to implement a simple method to dump all interesting processor state information. Such code can be tuned for the state of the particular processor and therefore can provide a summary of the processor state in a compact and concise format.

As discussed above, it is sometimes necessary for the debugger 16 to manually translate virtual addresses to physical addresses. Such translation is highly processor-dependent and is therefore abstracted through the selected block 36p of the processor abstraction 34. Each block 36p implements the processor-specified virtual-to-physical mapping. Such mapping generally requires access to memory through the selected block 36d of the debugger type abstraction 32 and may also require access to operating system dependent information through such selected block 36d.

As also discussed above, the selected block 36d of the debugger type abstraction 32 is responsible for inserting and removing breakpoints. In some cases, such selected block 36d accomplishes such tasks by actually inserting processor-specific break instructions into the instruction stream for a debuggee. In particular, such block 36d delegates the actual insertion to the selected block 36p of the processor abstraction 34 for the processor-specific part. The selected block 36p may in turn call back to the selected block 36d to manipulate memory in the debuggee.

In one embodiment of the present invention, the selected block 36p of the processor abstraction 34 has a set of methods for recognizing and classifying breakpoint instructions and exceptions. Such methods are used in various places to determine if the debuggee has hit a breakpoint and if so, what kind. The selected block 36p is also responsible for maintaining hardware breakpoints if the corresponding processor 12 supports such breakpoints. Generic code sets up global information describing exactly what hardware breakpoints are needed and then an InsertAllDataBreakpoints method is called. InsertAllDataBreakpoints passes over the requested hardware breakpoint information and carries out whatever processor-specific operations are necessary to configure the breakpoints.

In many cases, a debugger 16 must analyze a particular piece of code to gain more information about the exact state that a debuggee is in. An instruction set is specific to a particular processor family so such interpretation services are provided by the selected block 36p of the processor abstraction 34. Such interpretation services range from simple checks to see if a particular instruction is a call or return to determining the next instruction executed based on the current instruction and processor state.

Operation of the Debugger 16

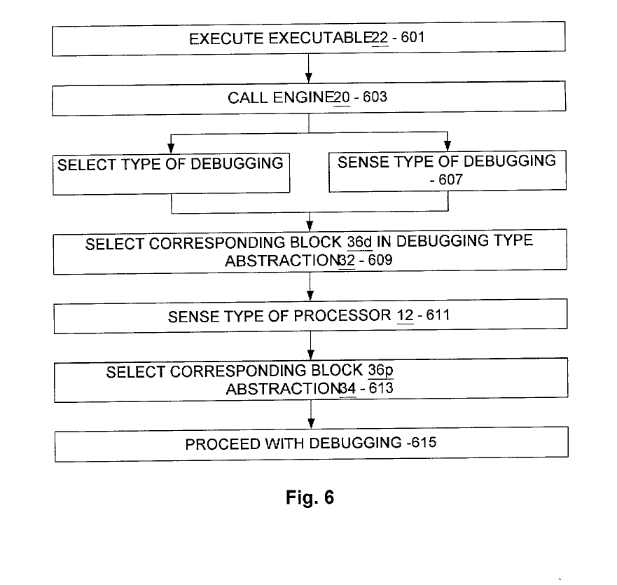

To operate the debugger 16 of the present invention, and referring now to FIG. 6, a user 24 executes an appropriate executable 22 which then calls the engine 20 (steps 601, 603). The user 24 either selects a particular type of debugging to perform on a debuggee (step 605), or the type of debugging is sensed where appropriate (e.g., when the debuggee is a dump file 14 from the kernel mode of a processor 12) (step 607). Based on the type of debugging selected/sensed, the corresponding block 36d in the debugging type abstraction 32 is selected for use (step 609). The type of processor 12 associated with the debuggee (a processor 12, a dump file 14, the host computer 18, an emulator 40, etc.) is then sensed by the engine 20 and a corresponding block 36p in the processor abstraction 34 is selected for use (steps 611, 613). Debugging may then proceed, with a considerable amount of intercommunication among the high level debugger code 30, the debugging type abstraction 32, the processor abstraction 34, and the debuggee (step 615).

Note that in selecting/sensing a type of debugging to be performed (steps 605, 607), such selecting/sensing is accomplished by determining, for a particular debuggee, a debugging type attribute of the particular debuggee. Such debugging type attribute may be a specific attribute encoded within the debuggee, or may be a non-encoded characteristic of the debuggee or the like, where such characteristic can be sensed by the debugger 16 and/or the user 24. For example, a dump file 14 may have the debugging type associated therewith encoded within such dump file 14. Correspondingly, a processor 12 may not explicitly note the debugging type associated therewith, but such debugging type may be surmised from other information available from such processor 12. Such debugger type attribute may also be identified by way of an identification thereof in the executable 22.

Similarly, it is to be noted that in sensing the type of processor 12 associated with a debuggee (step 611), such sensing is accomplished by determining, for a particular debuggee, a processor attribute of the particular debuggee. Again, such processor attribute may be a specific attribute encoded within the debuggee, or may be a non-encoded characteristic of the debuggee or the like, where such characteristic can be sensed by the debugger 16 and/or the user 24. For example, a dump file 14 may have the producing processor 12 associated therewith encoded within such dump file 14, and a processor 12 may have a type identification associated therewith. Correspondingly, a processor 12 may not explicitly note a type identification associated therewith, but such type of processor may be surmised from other information available from such processor 12. Such processor attribute may also be identified by way of an identification thereof in the executable 22.

### CONCLUSION

The programming necessary to effectuate the processes performed in connection with the present invention is relatively straight-forward and should be apparent to the relevant programming public. Accordingly, such programming is not attached hereto. Any particular programming, then, may be employed to effectuate the present invention without departing from the spirit and scope thereof.

In the foregoing description, it can be seen that the present invention comprises a new and useful debugger 16 having a single debugger engine 20 that supports multiple debugging types and multiple processors 12 such that supporting, updating, and maintaining the single debugger engine 20 and the debugger 16 is greatly simplified. The single debugger engine 20 supports dynamic selection from among the multiple debugging types and multiple processors 12 and thereby supports all available debugging operations. Thus, a debugger user 24 need not be concerned with selecting a particular debugger 16 for debugging. It should be appreciated that changes could be made to the embodiments described above without departing from the inventive concepts thereof. It should be understood, therefore, that this invention is not limited to the particular embodiments disclosed, but it is intended to cover modifications within the spirit and scope of the present invention as defined by the appended claims.

1. A debugger for debugging any of a plurality of debuggees, each debuggee having a debugging type attribute selected from a plurality of debugging type attributes and representative of a type of debugging to be performed with respect to the debuggee, each debuggee also having a processor attribute selected from a plurality of processor attributes and representative of a type of processor associated with the debuggee, the debugger being instantiated on a computer and comprising:
an engine for performing debugging functions with respect to any of the plurality of debuggees, the engine including:
a plurality of debugging type blocks, each debugging type block for supporting at least one of the plurality of debugging type attributes; and
a plurality of processor blocks, each processor block for supporting at least one of the plurality of processor attributes,
wherein a particular debugging type block and a particular processor block are selected for debugging a particular debuggee based on the debugging type attribute and processor attribute of the particular debuggee.

2. The debugger of claim 1 wherein the plurality of debugging type blocks are organized into a debugging type abstraction available to provide debugging type services that vary in implementation for each debugging type.

3. The debugger of claim 2 wherein the debugging services include services selected from a group consisting of accessing memory, accessing context, accessing system information, inserting a breakpoint, removing a breakpoint, controlling execution, and combinations thereof.

4. The debugger of claim 2 wherein the debugging type abstraction comprises programming code, and wherein at least a portion of the programming code for the debugging type abstraction is common as between at least some debugging type blocks and is shared by such debugging type blocks.

5. The debugger of claim 4 wherein the programming code for the debugging type abstraction is organized into a tree form with generic code at a base node and more specific levels of code branching out at nodes therefrom, each debugging type block including at least one node from the tree.

6. The debugger of claim 1 wherein the plurality of processor blocks are organized into a processor abstraction available to provide processor services that vary in implementation for each processor.

7. The debugger of claim 6 wherein the processor services include services selected from a group consisting of recognizing particular processor instructions, recognizing processor states, maintaining hardware breakpoints, assembling code for the processor, disassembling code from the processor, disassembling code from a dump file produced by the processor, and combinations thereof.

8. The debugger of claim 6 wherein the processor abstraction comprises programming code, and wherein at least a portion of the programming code for the processor abstraction is common as between at least some processor blocks and is shared by such processor blocks.

9. The debugger of claim 8 wherein the programming code for the processor abstraction is organized into a tree form with generic code at a base node and more specific levels of code branching out at nodes therefrom, each processor block including at least one node from the tree.

10. The debugger of claim 1 wherein the engine further includes a high level portion for issuing generic requests to the selected debugging type block and to the selected processor block to accomplish debugging actions.

11. The debugger of claim 10 wherein the plurality of debugging type blocks are organized into a debugging type abstraction available to provide debugging type services that vary in implementation for each debugging type, wherein the plurality of processor blocks are organized into a processor abstraction available to provide processor services that vary in implementation for each processor, and wherein the high level portion issues generic requests to the debugging type abstraction and to the processor abstraction to accomplish debugging actions.

12. The debugger of claim 1 wherein the plurality of debugging type attributes supported by the debugging type blocks include debugging type attributes representative of members selected from a group consisting of user mode debugging, kernel mode debugging, dump file debugging, and combinations thereof.

13. The debugger of claim 12 wherein the plurality of debugging type attributes supported by the debugging type blocks further include debugging type attributes representative of members selected from a group consisting of user mode dump file debugging, kernel mode dump file debugging, and combinations thereof.

14. The debugger of claim 1 wherein the plurality of processor attributes supported by the processor blocks include processor attributes representative of members selected from a group consisting of an X86 processor family, an ALPHA processor family, an IA64 processor family, and combinations thereof.

15. The debugger of claim 1 wherein the debugger further has an executable for being executed by a user, for calling the engine, and for providing an interface between the user and the engine.

16. The debugger of claim 15 wherein the executable includes an attribute that results in the selection of a particular debugging type block in the engine.

17. The debugger of claim 15 wherein the executable includes an attribute that results in the selection of a particular processor block in the engine.

18. The debugger of claim 1 wherein the particular debuggee is a dump file produced by a processor operating a particular mode, wherein the debugging type attribute of the dump file corresponds to the particular mode, and wherein the particular debugging type block of the engine selected for debugging the dump file supports the debugging type attribute of the dump file.

19. The debugger of claim 1 wherein the particular debuggee is a dump file produced by a type of processor, wherein the processor attribute of the dump file corresponds to the type of processor, and wherein the particular processor block of the engine selected for debugging the dump file supports the processor attribute of the dump file.

20. A computer having a debugger instantiated thereon for debugging any of a plurality of debuggees, each debuggee having a debugging type attribute selected from a plurality of debugging type attributes and representative of a type of debugging to be performed with respect to the debuggee, each debuggee also having a processor attribute selected from a plurality of processor attributes and representative of a type of processor associated with the debuggee, the debugger comprising:
an engine for performing debugging functions with respect to any of the plurality of debuggees, the engine including:
a plurality of debugging type blocks, each debugging type block for supporting at least one of the plurality of debugging type attributes; and
a plurality of processor blocks, each processor block for supporting at least one of the plurality of processor attributes,
wherein a particular debugging type block and a particular processor block are selected for debugging a particular debuggee based on the debugging type attribute and processor attribute of the particular debuggee.

21. The computer of claim 20 wherein the plurality of debugging type blocks are organized into a debugging type abstraction available to provide debugging type services that vary in implementation for each debugging type.

22. The computer of claim 21 wherein the debugging type abstraction comprises programming code, and wherein at least a portion of the programming code for the debugging type abstraction is common as between at least some debugging type blocks and is shared by such debugging type blocks.

23. The computer of claim 22 wherein the programming code for the debugging type abstraction is organized into a tree form with generic code at a base node and more specific levels of code branching out at nodes therefrom, each debugging type block including at least one node from the tree.

24. The computer of claim 20 wherein the plurality of processor blocks are organized into a processor abstraction available to provide processor services that vary in implementation for each processor.

25. The computer of claim 24 wherein the processor abstraction comprises programming code, and wherein at least a portion of the programming code for the processor abstraction is common as between at least some processor blocks and is shared by such processor blocks.

26. The computer of claim 25 wherein the programming code for the processor abstraction is organized into a tree form with generic code at a base node and more specific levels of code branching out at nodes therefrom, each processor block including at least one node from the tree.

27. The computer of claim 20 wherein the engine further includes a high level portion for issuing generic requests to the selected debugging type block and to the selected processor block to accomplish debugging actions.

28. The computer of claim 27 wherein the plurality of debugging type blocks are organized into a debugging type abstraction available to provide debugging type services that vary in implementation for each debugging type, wherein the plurality of processor blocks are organized into a processor abstraction available to provide processor services that vary in implementation for each processor, and wherein the high level portion issues generic requests to the debugging type abstraction and to the processor abstraction to accomplish debugging actions.

29. The computer of claim 20 wherein the debugger further has an executable for being executed by a user, for calling the engine, and for providing an interface between the user and the engine.

30. The computer of claim 29 wherein the executable includes an attribute that results in the selection of a particular debugging type block in the engine.

31. The computer of claim 29 wherein the executable includes an attribute that results in the selection of a particular processor block in the engine.

32. A method comprising:
determining, for a particular debuggee, a debugging type attribute of the particular debuggee;
selecting a particular debugging type block of an engine of a debugger for debugging the particular debuggee based on the determined debugging type attribute;
determining, for the particular debuggee, a processor attribute of the particular debuggee;
selecting a particular processor block of the engine of the debugger for debugging the particular debuggee based on the determined processor attribute; and
employing the selected debugging type block and the selected processor block to debug the particular debuggee.

33. The method of claim 32 wherein determining the debugging type attribute comprises receiving a selection of a particular type of debugging from a user.

34. The method of claim 32 wherein determining the processor attribute comprises sensing a particular type of processor from the debuggee.

35. The method of claim 32 wherein determining the debugging type attribute comprises sensing a particular type of debugging from the debuggee.

36. The method of claim 32 further comprising employing a high level portion of the engine of the debugger to issue generic requests to the selected debugging type block and to the selected processor block to accomplish debugging actions.

37. The method of claim 36 wherein employing the high level portion comprises issuing generic requests from the high level portion to a debugging type abstraction and to a processor abstraction to accomplish debugging actions, the debugging type abstraction comprising a plurality of debugging type blocks and being available to provide debugging type services that vary in implementation for each debugging type, the processor abstraction comprising a plurality of processor blocks and being available to provide processor services that vary in implementation for each processor.

38. The method of claim 32 further comprising running an executable of the debugger in response to a command from a user, the executable for calling the engine and for providing an interface between the user and the engine.

39. The method of claim 38 wherein the executable includes an identification of the debugging type attribute of the debuggee, the method comprising selecting the particular debugging type block in the engine based on the identification.

40. The method of claim 38 wherein the executable includes an identification of the processor attribute of the debuggee, the method comprising selecting the particular processor block in the engine based on the identification.

41. The method of claim 32 in combination with a debugger for debugging any of a plurality of debuggees, each debuggee having a debugging type attribute selected from a plurality of debugging type attributes and representative of a type of debugging to be performed with respect to the debuggee, each debuggee also having a processor attribute selected from a plurality of processor attributes and representative of a type of processor associated with the debuggee, the debugger having an engine for performing debugging functions with respect to any of the plurality of debuggees, the engine including:
a plurality of debugging type blocks, each debugging type block for supporting one of the plurality of debugging type attributes; and
a plurality of processor blocks, each processor block for supporting one of the plurality of processor attributes,
the method comprising:
determining, for a particular debuggee, the debugging type attribute of the particular debuggee;
selecting a particular debugging type block for debugging the particular debuggee based on the determined debugging type attribute;
determining, for a particular debuggee, the processor attribute of the particular debuggee;
selecting a particular processor block for debugging the particular debuggee based on the determined processor attribute; and
employing the selected debugging type block and the selected processor block to debug the particular debuggee.

42. A computer-readable medium having computer-executable instructions thereon, the instructions being organized into modules comprising:
a first module for determining, for a particular debuggee, a debugging type attribute of the particular debuggee;
a second module for selecting a particular debugging type block of an engine of a debugger for debugging the particular debuggee based on the determined debugging type attribute;
a third module for determining, for the particular debuggee, a processor attribute of the particular debuggee;
a fourth module for selecting a particular processor block of the engine of the debugger for debugging the particular debuggee based on the determined processor attribute; and
a fifth module for employing the selected debugging type block and the selected processor block to debug the particular debuggee.

43. The medium of claim 42 wherein the first module determines the debugging type attribute by receiving a selection of a particular type of debugging from a user.

44. The medium of claim 42 wherein the third module determines the processor attribute by sensing a particular type of processor from the debuggee.

45. The medium of claim 42 wherein the first module determines the debugging type attribute by sensing a particular type of debugging from the debuggee.

46. The medium of claim 42 further comprising a sixth module for employing a high level portion of the engine of the debugger to issue generic requests to the selected debugging type block and to the selected processor block to accomplish debugging actions.

47. The medium of claim 46 wherein the sixth module issues generic requests from the high level portion to a debugging type abstraction and to a processor abstraction to accomplish debugging actions, the debugging type abstraction comprising a plurality of debugging type blocks and being available to provide debugging type services that vary in implementation for each debugging type, the processor abstraction comprising a plurality of processor blocks and being available to provide processor services that vary in implementation for each processor.

48. The medium of claim 42 further comprising a sixth module for running an executable of the debugger in response to a command from a user, the executable for calling the engine and for providing an interface between the user and the engine.

49. The medium of claim 48 wherein the executable includes an identification of the debugging type attribute of the debuggee, the second module selecting the particular debugging type block in the engine based on the identification.

50. The medium of claim 48 wherein the executable includes an identification of the processor attribute of the debuggee, the fourth module selecting the particular processor block in the engine based on the identification.
